(19) United States
(12) Patent Application Publication
(10) Pub. No.: US 2017/0272732 A1
(43) Pub. Date: Sep. 21, 2017

(54) WAVELENGTH MULTIPLEXING VISUALIZATION USING DISCRETE PIXELS

(71) Applicant: Disney Enterprises, Inc., Burbank, CA (US)

(72) Inventors: Paul Raymond Bailey, Burbank, CA (US); Thomas Tracey TAIT, Santa Clarita, CA (US); Mark A. REICHOW, Valencia, CA (US); Quinn Yorklun Jen SMITHWICK, Pasadena, CA (US); Alexander Wei-Heng HSING, Glendale, CA (US)

(21) Appl. No.: 15/073,233

(22) Filed: Mar. 17, 2016

(51) Int. Cl. H04N 13/04; G02B 27/22

(52) U.S. Cl. CPC H04N 13/044; H04N 13/0422; G02B 27/2207; H04N 13/0431

(57) ABSTRACT

Embodiments herein describe a display device for performing wavelength multiplex visualization (WMV). The display device includes a display screen that includes a plurality of pixels where each pixel contains at least two discrete emitters that generate electromagnetic radiation at a certain wavelength. By controlling the luminance of the respective emitter, the display device sets the color of the pixel. When performing WMV, the display device uses the pixels to generate a left eye display frame and a right eye display frame. Generally, the left eye frame is generated using a different set of wavelengths than the right eye frame. The user can wear special glasses that have interference filters in the lenses which permit only one of the wavelengths to pass through. As a result, each eye of the user sees only one of the display frames, thereby creating the 3D effects.

### BACKGROUND

Field of the Invention

Embodiments presented in this disclosure generally relate to displaying 3D media using wavelength multiplex visualization.

Description of the Related Art

Wavelength multiplex visualization is one technique for displaying stereoscopic images for 3D media. For example, a projector may output left and right stereoscopic images simultaneously. A color wheel can be placed in the projector which contains red, green, and blue filters which use two different sets of wavelengths for the left and right stereoscopic images. A user viewing the 3D media projected onto a screen (e.g., a screen in a movie theater) wears special glasses that have lenses that permit one set of the wavelengths to pass through, but filters the other set. For example, the lens over the left eye of the user permits the wavelengths used to generate the left stereoscopic image to pass through but filters (i.e., blocks) the wavelengths used to generate the right stereoscopic image. The reverse is also true where the lens over the right eye permits only the wavelengths used in the right stereoscopic image to pass. In this manner, the left eye receives only the left stereoscopic images and the right eye receives only the right stereoscopic images which enable the viewer to perceive 3D effects.

### SUMMARY

One embodiment presented herein is display device that includes a display screen comprising a plurality of pixels, each of the pixels comprising at least a first discrete emitter and a second discrete emitter, and the first and second emitters are configured to generate visible light with different wavelengths. The display device includes a display controller configured to drive the pixels to output a left eye frame, wherein the left eye frame is associated with a first set of wavelengths and drive the pixels to output a right eye frame, wherein the right eye frame is associated with a second set of wavelengths different from the first set of wavelengths, and wherein the left eye frame and the right eye frame generate 3D effects when viewed by a user.

Another embodiment presented herein is a display screen that includes a plurality of pixels, each of the pixels includes at least a first discrete emitter and a second discrete emitter, and the first and second emitters are configured to generate visible light with different wavelengths. Moreover, the pixels are configured to output a left eye frame associated with a first set of wavelengths and the pixels are configured to output a right eye frame associated with a second set of wavelengths different from the first set of wavelengths, and wherein the left eye frame and the right eye frame generate 3D effects when viewed by a user.

Another embodiment presented herein is a computer-readable storage medium including instructions that, when executed by a processor, cause the processor to perform an operation. The operation includes driving a plurality of pixels to output a left eye frame, where the left eye frame is associated with a first set of wavelengths, and each of the pixels comprises at least a first discrete emitter and a second discrete emitter. Moreover, the first and second emitters are configured to generate visible light with different wavelengths. The operation also includes driving the pixels to output a right eye frame, where the right eye frame is associated with a second set of wavelengths different from the first set of wavelengths, and the left eye frame and the right eye frame generate 3D effects when viewed by a user.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an optical system for performing wavelength multiplex visualization, according to one embodiment described herein.

FIG. 2 is a block diagram of a display device for performing wavelength multiplex visualization, according to one embodiment described herein.

FIG. 3 illustrates a display screen with multiple pixels and emitters for performing wavelength multiplex visualization, according to one embodiment described herein.

FIGS. 4A and 4B illustrate driving a pixel for performing wavelength multiplex visualization, according to one embodiment described herein.

FIG. 5 illustrates a display stack up for performing wavelength multiplex visualization using a tunable filter layer, according to one embodiment described herein.

### DETAILED DESCRIPTION

Embodiments herein describe a display device for performing wavelength multiplex visualization (WMV). The display device includes a display screen that includes a plurality of pixels. Furthermore, each pixel contains at least two discrete emitters—e.g., a light emitting diode (LED) or quantum dot—that generate electromagnetic radiation within a certain wavelength range. In one embodiment, each pixel may include a red emitter, a green emitter, and a blue emitter. By controlling the luminance (or brightness) of the light generated by the emitters, the display device sets the color of the pixel. In one embodiment, the color of the pixels is set according to data included in a display frame.

When performing WMV, the display device uses the pixels to generate a left eye display frame and a right eye display frame which capture the same image from two different perspectives. The display device may output the left and right display frames either simultaneously or during different time periods. Generally, the left eye frame is generated using a different set of wavelengths than the right eye frame. For example, the display frames may set a red, green, and blue luminance values for each of the emitters in the pixels. Depending on the luminance values, the light emitted by the red, green, and blue emitters combines to produce the desired color of the pixel. However, the wavelengths generated by the red, blue, and green emitters when outputting the left and right eye frames may be different. For example, when outputting the left eye frame, the red luminance values may be transmitted using a 630 nm wavelength, while the red luminance values of the right eye frame are transmitted using a 615 nm wavelength. The user can wear special glasses that have interference filters in the lenses which permit only one of the wavelengths to pass through. For example, the lens in front of the user's left eye permits 630 nm wavelength light to pass through but blocks 615 nm wavelength light. As a result, the left eye sees the left eye frame but not the right eye frame. Conversely, the lens in front of the user's right eye permits 615 nm wavelength light to pass through but blocks the 630 nm wavelength light used by the left eye frame. As a result, each eye of the user sees only one of the display frames, thereby creating the 3D effects. And while the wavelengths for a particular color are not identical (e.g. 615 nm versus 630 nm) the slight variation in shade between the left and right eyes is not perceptible to the human eye.

In one embodiment, each pixel in the display device includes respective emitters for generating the left and right eye frames. For example, if the display device uses a red, green, and blue (RGB) color scheme, each pixel in the device includes six emitters—a first set of red, green and blue emitters for generating the right eye frame and a second set of red, green and blue emitters for generating the left eye frame. In this embodiment, the left and right eye frames can be displayed simultaneously by the display device.

In another embodiment, the display device uses the same set of emitters to generate the left and right eye frames. In other words, each pixel in the display device uses the same emitters to display both the right and left eye frames. For example, during a first time period, the display device drives the emitters in a pixel to transmit wavelengths corresponding to the right eye frame, but during a second time period, the device drives the same emitters in a different manner to transmit wavelengths corresponding to the left eye frame. Although the same emitters are used, by changing the frequency or voltage at which the emitters are driven, the display device can shift the wavelength of the radiation outputted by the emitters thereby generating the left and right eye frames using two different time periods.

In another embodiment, the display device includes a tunable filter disposed between the pixels and a protective cover. The tunable filter can alter or shift the wavelengths generated by the emitters in the pixels. For example, the red emitters in the pixel may generate light with a bandwidth between 610 nm and 630 nm. When displaying the left eye frame, the display device may tune the filter such that wavelengths near 615 nm (e.g., within +/−5 nm) pass through the filter while wavelengths near 630 nm are blocked. Conversely, when display the right eye frame, the display device tunes the filter such that the wavelengths near 630 nm pass through while wavelengths near 615 nm are blocked. In this example, the pixel can contain emitters that emit light having bandwidths that include wavelengths corresponding to both the left and right eye frames but use the tunable filter to filter the light to generate narrower bandwidth signals corresponding to only one of the left and right eye frames.

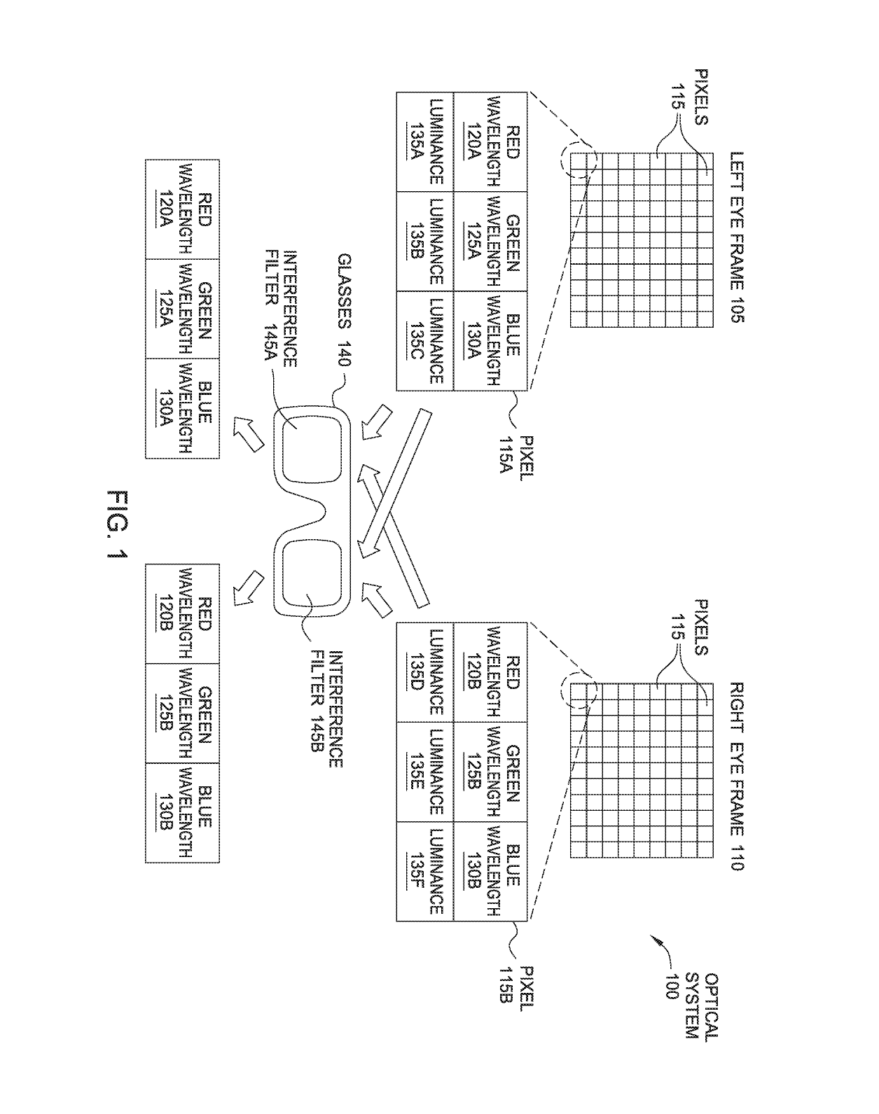

FIG. 1 illustrates an optical system 100 for performing WMV, according to one embodiment described herein. The optical system 100 includes left eye frame 105 and right eye frame 110. The frames 105 and 110 are made up of a plurality of pixels 115 that each correspond to a single color. The number of pixels 115 in the frames 105 and 110 may vary depending on the desired resolution of the optical system 100. For example, the resolution (e.g., the number of pixels per unit of area) may be smaller for optical systems 100 implemented in a mobile device (e.g., a smartphone or tablet computer) than for a standalone television. As viewed as a whole, the colored pixels 115 display an image as part of a media presentation. In one example, the media presentation may include multiple left eye and right eye frames that when displayed in sequence, generate 3D effects.

As shown in the blown out image of pixel 115A, each of the pixels corresponds to a set of wavelengths used to transmit red, blue, and green luminance (or brightness) values. For example, the pixel 115A uses a red wavelength 120A, green wavelength 125A, and blue wavelength 130A to output the luminance values 135A, 1356, and 135C, respectively, while pixel 115B uses a red wavelength 120B, green wavelength 125B, and blue wavelength 130B to output the luminance values 135D, 135E, and 135F, respectively. However, the wavelengths used by the pixels 115 in the left eye frame 105 are different than the wavelengths used by the pixels 115 in the right eye frame 110 which include a red wavelength 120B, a green wavelength 125B, and a blue wavelength 130B. For example, the red wavelength 120A may be 630 nm wavelength, the green wavelength 125A is 530 nm, and the blue wavelength 130A is 445 nm; while the red wavelength 120B may be 615 nm, the green wavelength 125B is 515 nm, and the blue wavelength 130B is 430 nm. As such, the left and right eye frames 105, 110 are generated using the same colors (e.g., red, green, and blue) but different shades of those colors. For example, the red wavelength 120A of 615 nm for the left eye frame 105 is a slightly different shade of red than the 630 nm red wavelength 120B used to output the right eye frame 110. Similarly, the left eye frame 105 corresponds to a different shade of green and blue than the right eye frame 110.

In one example, the wavelengths may encompass a range of wavelengths. For example, the red wavelength 120A may include wavelengths between 625 nm-635 nm, while the red wavelength 120B includes wavelengths between 610 nm-620 nm. Nonetheless, the wavelength ranges assigned to the left eye frame 105 and the right eye frame 110 are different (i.e., do not completely overlap) and, in one embodiment, include only mutually exclusive wavelengths. Moreover, the wavelengths and the wavelength ranges provided herein are only a few of the examples of different shades of wavelengths that could be used to perform WMV.

The luminance values for each pixel 115 determine the color of the pixel 115. For example, if the red and blue luminance values 135A and 135C are high while the green luminance value 135B is low, then the user sees the color purple at the location of the pixel 115A in the left eye frame 105. In one embodiment, the luminance values 135 are controlled by adjusting the amplitudes of the signals transmitted using the red, green, and blue wavelengths 120, 125, and 130.

The arrows in FIG. 1 illustrate that the signals representing the pixels 115A and 115B strike both lenses in a pair of glasses 140 worn by the user. However, the lenses include interference filters 145 which prevent the wavelengths corresponding to one of the frames 105 and 110 from passing through the lenses. In this example, interference filter 145A prevents the red, green, and blue wavelengths 120B, 125B, and 1306 of the right eye frame 110 from reaching the left eye of the user, while interference filter 145B prevents the red, green, and blue wavelengths 120A, 125A, and 130A of the left eye frame 105 from reaching the right eye. As such, only the pixels 115 in the left eye frame 105 are viewed by the left eye of the user, while only the pixels 115 in the right eye frame 110 are viewed by the right eye of the user.

Although this disclosure describes the interference filters 145 as being able to completely filter out the wavelengths from one the frames 105 and 110 while allowing the wavelengths of the other frame to pass through, when implemented using real-world materials, a complete extinction of the undesired signals may not be achieved. In one embodiment, the interference filters 145 block about more than 90% of the signals that have the wavelengths corresponding to the other (undesired) frame. For example, the interference filter 145A filters out 96% to 98% of the signals transmitted at the red, green, and blue wavelengths 120B, 125B, and 130B of the right eye frame 110, while the remaining portions of these signals pass through the filter 145A and thus are viewed by the left eye of the user. The percentage of extinction may vary depending on the angle at which the glasses 140 are oriented relative to the display device outputting the frames 105 and 110 as well as the materials and quality of the interference filters 145. Although 100% extinction is desired since this enhances the 3D effects and minimizes motion sickness, less than 100% extinction can still enable the user to perceive the 3D effects. Moreover, WMV can typically achieve higher extinction percentages than other 3D technologies that rely on polarizing light or using shutter glasses which only achieve between 10-25% extinction percentages. Moreover, unlike shutter glasses, the glasses 140 are passive which means they do not require any electronics or power in order to selectively filter the wavelengths corresponding to the frames 105 and 110.

As shown in FIG. 1, the signals transmitted using the red, green, and blue wavelengths 120A, 125B, and 130A from the left eye frame 105 pass through the interference filter 145A and reach the left eye, while the signals transmitted using the red, green, and blue wavelengths 120B, 125B, and 130B from the right eye frame 110 pass through the interference filter 145B and reach the right eye. The same selective filtering process occurs for the other pixels 115 in the frames 105 and 110. Thus, the left eye of the user views substantially all the colors corresponding to the pixels 115 in the left eye frame 105 while the colors corresponding to the pixels 115 in the right eye frame 110 are attenuated—i.e., filtered out. In contrast, the right eye of the user views substantially all the colors correspond to the pixels 115 in the right eye frame 110 while the colors corresponding to the pixels 115 in the left eye frame 105 are attenuated.

The user can perceive 3D effects regardless whether the left and right eye frames 105, 110 are displayed simultaneously by a display device (not shown) in the optical system 100 or if the frames 105, 110 are displayed sequentially during non-overlapping time periods. Different techniques and arrangements from outputting the left eye and right eye frames 105, 110 are provided below.

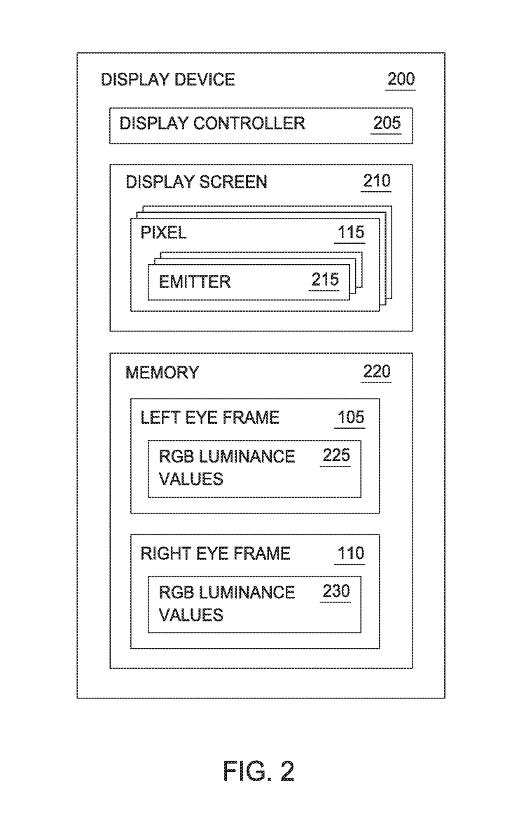

FIG. 2 is a block diagram of a display device 200 for performing WMV, according to one embodiment described herein. The display device 200 includes a display controller 205, a display screen 210, and memory 220. The display controller 205 may include hardware and/or software which controls the images displayed on the screen 210. For example, the display controller 205 receives display frames from a media broadcast transmitted by a service provider (e.g., a cable, satellite, or internet streaming provider) or a physical computer readable media such as a DVD. In one embodiment, the display controller 205 receives left eye frames 105 and right eye frames 110 which the controller 205 stores in the memory 220. As described above, the left eye frame 105 includes RGB values 225 that differ from the RGB values 230 in the right eye frame 110 in order to generate 3D effects. Although the embodiments herein describe using an RGB color scheme, other color schemes may also be used.

The display controller 205 outputs the left eye frame 105 and the right eye frames 110 on the display screen 210 in a predefined order. Each pixel 115 in the display screen includes multiple emitters 215 for displaying a particular color corresponding to the pixel. Using the RGB color scheme, the light generated by the emitters 215 combines to set the color of the pixel 115. That is, the RGB values 225 and 230 set the luminance or brightness of each of the emitters 215 in a pixel 115 so that the light generated by the emitters 215 combine to output the desired pixel color.

In one embodiment, the emitters 215 are organic light emitting diodes (OLED) or quantum dots. More generally, the emitters 215 can be any light source that emits light natively. In contrast, many display technologies (e.g., LCD) rely on backlights to output the display frames. Instead of generating the light, the liquid crystal in the pixels filters light emitted by the backlight so that only light with the desired wavelength passes through the pixel. Moreover, the liquid crystal attenuates the light so the red, green, and blue light has the desired luminance value. In contrast, the pixels 115 in display screen 210 are individual pixels that generate light having different wavelengths using the discrete emitters 215. In one embodiment, the display screen 210 does not include a backlight and relies on the light generated by the individual emitters 215 in the pixels 115 to generate an image. OLED and quantum dots are non-limiting examples of display screens that rely on pixels with discrete emitters to output display frames. Furthermore, display device 200 differs from using a projector which may include one or more laser sources for performing WMV. For example, the projector rasters the laser across a projection screen (e.g., a movie screen) to generate the left eye and right eye frames. Here, the display device 200 includes multiple pixels which each include discrete emitters (e.g., emitters that can be controlled individually) rather than using a one or more laser sources for outputting the display frames.

However, if lasers rather than discrete emitters are used to perform WMV, instead of using six lasers (one set of RGB lasers to generate the left eye image and a second set of RGB lasers to generate the right eye image) only one set of RGB lasers can be used. In one embodiment, the red, green, and blue lasers can pass through respective acousto-optic modulators (AOMs) or electro-optic modulators (EOMs) which selectively shift the frequencies of the red, blue, and green light to produce two sets of RGB frequencies for generating left and right eye images. For example, the AOMs can shift the red, green, and blue light by +/−15 nm to generate a first set of wavelengths (e.g., 445 nm, 530 nm, 630 nm) and a second set of wavelengths (e.g., 415 nm, 500 nm, 600 nm). In one embodiment, although not yet practical, the AOMs can include an acoustic laser (e.g., a SASER) that outputs a 12 THz acoustic wave which results in the +/−15 nm shift.

In another embodiment, a set of three widely tuneable lasers or optical parameter oscillators (OPO) can be used to perform WMV. During a first time period, these RGB light sources are tuned to output wavelengths corresponding to a left eye image (e.g., 445 nm, 530 nm, 630 nm), but during a second time period are tuned to output wavelengths corresponding to a right eye image (e.g., 415 nm, 500 nm, 600 nm). These three tuneable light sources can then be rastered across a projection screen to generate the stereoscopic images for 3D media.

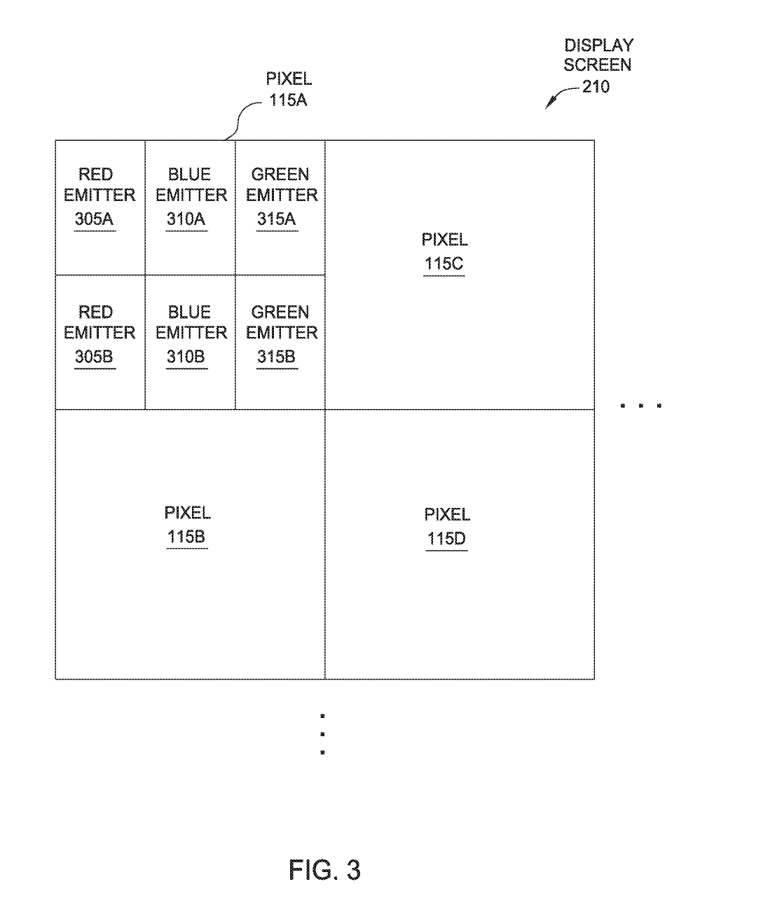

FIG. 3 illustrates the display screen 210 with multiple pixels 115 and emitters for performing WMV, according to one embodiment described herein. In this embodiment, each pixel 115 includes six emitters where three emitters output a pixel for the left eye frame and the other three emitters output a pixel for the right eye frame. As shown, pixel 115A includes two red emitters 305, two blue emitters 310, and two green emitters 315. The emitters 305A, 310A, and 315A generate light that corresponds to a pixel in the left eye frame, while the emitters 305B, 310B, and 315B generate light that corresponds to a pixel in the right eye frame. This same structure is repeated in the other pixels 115 in the display screen 210. As such, pixels 115B-D also include six individual emitters (not shown) for displaying other pixels in the left eye and right eye frames.

Because each pixel 115 includes three emitters for each of the left eye frame and the right eye frame, the two frames can be displayed simultaneously on the display screen 210. So long as the user is wearing the glasses with the interference filters, each eye views only the pixels of the either the left eye frame or the right eye frame.

Although FIG. 3 illustrates the six emitters being disposed side-by-side along a common plane, this is not a requirement. For example, some OLED display screens permit the different emitters to be disposed on different layers. For example, the red emitters 305A and 305B may be formed on a first layer, the blue emitters 310A and 310B are formed on a second layer, and the green emitters 315A and 315B are formed on a third layer in a display stack. The outputs of the emitters may be compensated to achieve balance amongst the emitters. For example, if the red emitters 305A and 305B are at the bottom of the stack, the display controller may increase the luminance of these emitters to compensate for the attenuation caused by the red light passing through the layers containing the blue and green emitters. By stacking the emitters in multiple layers, the size each pixel 115 takes up on the display screen 210 may be reduced.

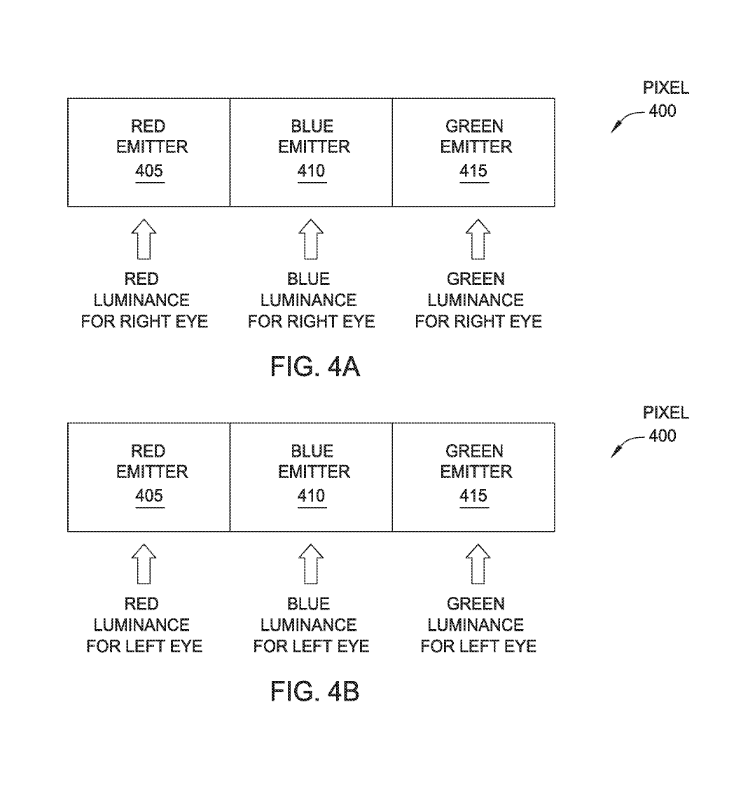

FIGS. 4A and 4B illustrates driving a pixel 400 for performing WMV, according to one embodiment described herein. Unlike the pixels in FIG. 3, pixel 400 includes only three emitters—i.e., a red emitter 405, a blue emitter 410, and a green emitter 415. FIG. 4A illustrates the state of the pixel 400 during a first time period when the display screen outputs the right eye frame. During the first time period, the display controller drives currents on the red, blue, and green emitters 405, 410, and 415 which cause these emitters to output the corresponding luminance values for the pixel 400 in the right eye display frame.

FIG. 4B illustrates the state of the pixel 400 during a second time period when the display screen outputs the left eye frame. During the second time period, the display controller drives voltages on the red, blue, and green emitters 405, 410, and 415 which cause the emitters to output the corresponding luminance values for the pixel 400 in the left eye frame. However, the display controller drives the emitters 405, 410, and 415 in a manner such that the wavelengths of the visible light generated by the emitters 405, 410, and 415 during the second time period are different from the wavelengths of the signals outputted during the first time period shown in FIG. 4A. In one embodiment, the display controller switches the bias voltage used to drive the emitters which can cause the wavelengths of the light generated by the emitters to shift. For example, at time A, the red emitter 405 outputs light at 615 nm, but at time B, outputs light at 630 nm. Once the wavelength is shifted, the display controller can alter the voltage in order to output the desired luminance values for the red, blue, and green emitters 405, 410, and 415. In this manner, each pixel 400 in a display screen can be time multiplexed to output the left eye and right eye frames using the same emitters.

The time multiplexing process shown in FIGS. 4A and 4B can be performed on all the pixels in the display screen. For example, during the first time period, all the pixels in the display screen are driven such that their respective red, blue, and green emitters 405, 410, and 415 output light with wavelengths corresponding to the right eye frame. The luminance values on the emitters, however, may differ if the colors of the pixels in the right eye frame are different. For example, the red, green, and blue luminance values for pixel 400 may be different than the luminance values of a neighboring pixel which has a different assigned color in the right eye frame. Nonetheless, the wavelengths used by all the red emitters, all the green emitters, and all the blue emitters during the first time period are the same. During the second time period, all the pixels are then driven such that the emitters 405, 410, and 415 output light with wavelengths corresponding to the left eye frame. Again, the luminance values may differ, but all the red emitters output light at the same wavelength, all the blue emitters output light at the same wavelength, and all the green emitters output light at the same wavelength.

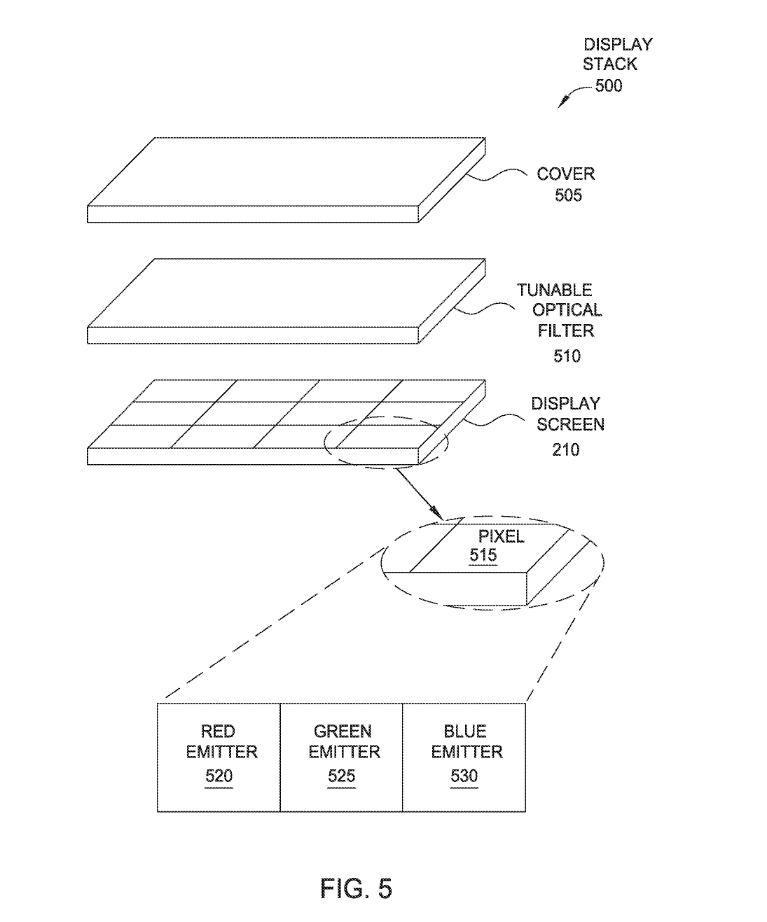

FIG. 5 illustrates a display stack 500 for performing WMV using a tunable filter layer, according to one embodiment described herein. The display stack 500 includes the display screen 210, a tunable optical filter 510, and a protective cover 505. In this embodiment, as shown by the blown out portion, each pixel 515 in the screen 210 includes a red emitter 520, a green emitter 525, and a blue emitter 530. In one embodiment, the emitters may generate light with a wide bandwidth that includes wavelengths assigned to both the left eye and right eye frames. For example, the red emitter 520 may generate light with wavelengths ranging from 600 nm to 640 nm. However, performing WMV may be best performed using wavelengths with narrow bandwidths—e.g., where most of light has wavelengths that range within +/−10 nm from a central wavelength.

The tunable filter 510 narrows the bandwidth of the light generated by the emitters in the pixel 515. For example, although the red emitter 120 may generate red light with wavelengths that range from 600 nm to 640 nm, after passing through the filter 510, most of the light has wavelengths ranging from 600 to 620 nm. Stated differently, the filter 510 removes or blocks most of the light with wavelengths ranging from 620 nm to 640 nm. As such, the tunable filter 510 narrows the bandwidth of the light emitted by the display device so that the light only has wavelengths corresponding to one of the left eye frame or the right eye frame. For example, wavelengths ranging from 600 nm to 620 nm may correspond to the right eye frame.

When transmitting the left eye frame, the display device changes one or more properties of the tunable optical filter 510 such that the filter 510 blocks a different set of wavelengths. For example, the tunable optical filter 510 may use a stack of Bragg reflectors. By applying a voltage, the spacing between the layers in the stack changes so the central frequency of the optical filter 510 shifts. Continuing the example above, before outputting the left eye frame, the display device changes the filter 510 to instead block the wavelengths ranging from 600 nm to 620 nm and permit wavelengths ranging from 620 nm to 640 nm to pass through. This range of wavelengths is assigned to the left eye frame. Once the filter 510 has been tuned to the wavelengths of the left eye frame, the display controller drives the red, green, and blue emitters 520, 525, and 530 to generate the color for the pixel 515 stipulated in the left eye frame. Before outputting another right eye frame, the display device again changes the properties of the tunable filter 510 so that the filter 510 blocks the wavelengths corresponding to the left eye frame but permit the wavelengths of the right eye frame to pass through.

In one embodiment, the filter 510 is a unitary layer that is controlled using a control signal—e.g., a voltage that is applied across the filter 510. By changing the control signal, the display device changes the properties of the filter 510 to dynamically filter the red, green, and blue wavelengths emitted by the pixels 515. In other embodiments, the tunable filter 510 may be subdivided into independent portions which cover respective emitters. For example, the filter 510 may include different sub sections that overlap each of the red emitters 520, green emitters 525, and blue emitters 530 in the pixels. In this manner, the display device can individually change the properties of the filter portions disposed over each of the emitters. For example, the filter portions disposed over the red emitters may include different materials (or combinations of materials) than the filter portions disposed over the green and blue emitters. Moreover, to change the properties of the filter, the display controller may need to use a different control signal each of the filter portions. For example, the display controller may use a first control signal for the filter portions over the red emitters, a second control signal for the filter portions over blue emitters, and a third control signal for the filter portions over the green emitters.

In one embodiment, the tunable filter is used even if the emitters do not emit light with wavelengths corresponding to both the left eye frame and the right eye frame. For example, the tunable filter may be used to tighten up the bandwidth of light generated by the emitters. Using FIGS. 4A and 4B as an example, when outputting the right eye frame, the red emitter 405 may generate light with wavelengths ranging from 610 to 620 nm. However, as the light passes through the tunable filter, the range is tightened to 613 nm to 618 nm. When outputting the right eye frame, the red emitter 405 may generate light with wavelengths from 625 nm to 635 nm. However, the tunable filter tightens this range between 628 nm to 633 nm. In this manner, the tunable filter can be used to further separate the wavelength ranges corresponding to the left eye and right eye frames which may improve the extinction ratio of the glasses. As mentioned above, improving the extinction ratio may improve the 3D effects and reduce the likelihood of motion sickness.

Moreover, the tunable filter may be used in a display device that uses a backlight, rather than individual emitters, to output the pixels of the left and right eye frames. For example, LCDs and other types of display devices use a liquid crystal material that is between the backlight and the user. Each pixel in the display device includes liquid crystal for filtering the white light generated by the backlight as it passes through the liquid crystal material to generate red, blue, and green light. By applying a voltage across the liquid crystal material, the display device controls the luminance of the light emitted from the pixels and determines the color of the pixel as described above. However, the display device is unable to change the wavelength of the light as it passes through the liquid crystal, and thus, cannot generate the left and right eye frames to perform WMV. However, when the tunable filter 510 is disposed on top of the liquid crystal, the display device can dynamically control the filter 510 to generate the left eye and right eye frames during separate time periods. For example, assume the red liquid crystal material filters the backlight to emit light in the range of 610-635 nm wavelengths. As above, the display device can control the tunable filter 510 such that the during a first time period, the wavelengths between 610 and 620 nm pass through the filter while the larger wavelengths are filtered. During a second time period, the display device changes the properties of the tunable optical filter 510 such that the wavelengths between 625-635 nm pass through the filter 510 while the smaller wavelengths emitted by the red liquid crystal material are filtered. The display device can control the attenuation or luminance of the light emitted at the different wavelengths during the two time periods to generate pixels for the left eye and right eye frames, respectively. This same process may be done by disposing the tunable filter over the green and blue portions of the liquid crystal material in each of the pixels. In this manner, a display device that includes a backlight for generating light for all the pixels in the screen can be adapted to perform WMV.

In another embodiment, instead of using the tunable optical filter 510, the display device may dispose a static (i.e., unchanging) optical filter over the pixels 515. For example, the pixels 515 may include the structure shown in FIG. 3 where each pixel includes six emitters—e.g., two red emitters 305, two green emitters 310, and two green emitters 315—to generate the left eye and right eye frames. However, unlike in FIG. 3 where the emitter pairs emit different wavelengths of light (e.g., the red emitter 305A outputs 615 nm while red emitter 305B outputs 630 nm), the emitters may natively generate light at the same, wide bandwidth. For example, both of the red emitters 305 output light that includes wavelengths between 610 and 635 nm, the blue emitters 310 output light at wavelengths between 423 and 450 nm, and the green emitters 315 output light at wavelengths between 510 and 535 nm. However, the portion of the static filter disposed over the red emitter 310A permits the only the light that has wavelengths in the range of 625-635 nm to pass through, while the portion of the static filter disposed over the red emitter 310B permits only the light that has wavelengths in the range of 610-620 nm to pass through. Similarly, other portions of the static filter are disposed over the green and blue emitters 310, 315 to filter out a portion of the wavelengths generated by these emitters to separate the light into different shades to perform WMV. In one embodiment, the material of the static filter may be different depending on whether it is disposed over a red, green, or blue emitter, and depending on what shade of the color should be emitted from the emitter. In this manner, the optical filter can be static, and thus, does not need to change dynamically. Moreover, by using the static filter, the emitters of the same color do not need to natively generate different shades of the same color, but can emit light with a broad range of wavelengths. Like in FIG. 3, the right eye and left eye frames can be displayed simultaneously when using the static optical filter.

In the preceding, reference is made to embodiments of the invention. However, it should be understood that the invention is not limited to specific described embodiments. Instead, any combination of the preceding features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the aspects, features, embodiments and advantages described herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A display device, comprising:
a display screen comprising a plurality of pixels, each of the pixels comprising at least a first discrete emitter and a second discrete emitter, wherein the first and second emitters are configured to generate visible light with different wavelengths; and
a display controller configured to:
drive the pixels to output a left eye frame, wherein the left eye frame is associated with a first set of wavelengths; and
drive the pixels to output a right eye frame, wherein the right eye frame is associated with a second set of wavelengths different from the first set of wavelengths, and wherein the left eye frame and the right eye frame generate 3D effects when viewed by a user.

2. The display device of claim 1, wherein the first set and second set of wavelengths are predefined to perform wavelength multiplexing visualization.

3. The display device of claim 1, wherein the first set of wavelengths comprises a first shade of a first color and a first shade of a second color, and wherein the second set of wavelengths comprises a second shade of the first color and a second shade of the second color.

4. The display device of claim 3, wherein the first set of wavelengths does not include the second shade of the first color and the second shade of the second color and wherein the second set of wavelengths does not include the first shade of the first color and the first shade of the second color.

5. The display device of claim 1, wherein each of the first and second emitters comprises one of an organic light emitting diode (OLED) and a quantum dot.

6. The display device of claim 1, wherein each of the pixels further comprises a third emitter and a fourth emitter, wherein the first and third emitters output visible light of a first color and the second and fourth emitters output visible light of a second color, wherein the first emitter outputs a different shade of the first color than the third emitter and the second emitter outputs a different shade of the second color than the fourth emitter.

7. The display device of claim 6, wherein the first and second emitters output luminance values corresponding to the left eye frame and the third and fourth emitters output luminance values corresponding to the right eye frame, wherein the first, second, third, and fourth emitters output the luminance values for the left and right eye frames simultaneously.

8. The display device of claim 1, wherein the first emitter generates visible light of a first color and the second emitter generates visible light of a second color, wherein the display controller is configured to:
during a first time period, drive the first emitter to generate a first shade of the first color and drive the second emitter to generate a first shade of the second color, wherein the first shades comprise wavelengths that are within the first set of wavelengths associated with the left eye frame, and
during a second time period, drive the first emitter to generate a second shade of the first color and drive the second emitter to generate a second shade of the second color, wherein the second shades comprise wavelengths that are within the second set of wavelengths associated with the right eye frame.

9. The display device of claim 1, further comprising:
a tunable optical filter overlaying the plurality of pixels,
wherein the display controller is configured to:
during a first time period, set a state of the tunable optical filter to filter visible light generated by the first and second emitters such that the filtered light comprises wavelengths that are within the first set of wavelengths associated with the left eye frame, and
during a second time period, change the state of the tunable optical filter to filter the visible light generated by the first and second emitters such that the filtered light comprises wavelengths that are within the second set of wavelengths associated with the right eye frame.

10. The display device of claim 1, wherein each of the pixels further comprises a third emitter and a fourth emitter, wherein the first and third emitters output visible light of a first color and the second and fourth emitters output visible light of a second color, the display device further comprising:
a static optical filter overlaying the plurality of pixels, wherein the static optical filter filters the visible light emitted by the first, second, third, and further emitters such that the visible light corresponding to the first emitter is a first shade of the first color, the visible light corresponding to the third emitter is a second shade of the first color, the visible light corresponding to the second emitter is a first shade of the second color, and the visible light corresponding to the fourth emitter is a second shade of the second color.

11. A display screen comprising:
a plurality of pixels, each of the pixels comprising at least a first discrete emitter and a second discrete emitter, wherein the first and second emitters are configured to generate visible light with different wavelengths,
wherein the pixels are configured to output a left eye frame associated with a first set of wavelengths, and
wherein the pixels are configured to output a right eye frame associated with a second set of wavelengths different from the first set of wavelengths, and wherein the left eye frame and the right eye frame generate 3D effects when viewed by a user.

12. The display screen of claim 11, wherein the first set and second set of wavelengths are predefined to perform wavelength multiplexing visualization.

13. The display screen of claim 11, wherein the first set of wavelengths comprises a first shade of a first color and a first shade of a second color, and wherein the second set of wavelengths comprises a second shade of the first color and a second shade of the second color.

14. The display screen of claim 13, wherein the first set of wavelengths does not include the second shade of the first color and the second shade of the second color and wherein the second set of wavelengths does not include the first shade of the first color and the first shade of the second color.

15. The display screen of claim 11, wherein each of the pixels further comprises a third emitter and a fourth emitter, wherein the first and third emitters output visible light of a first color and the second and fourth emitters output visible light of a second color, wherein the first emitter outputs a different shade of the first color than the third emitter and the second emitter outputs a different shade of the second color than the fourth emitter.

16. The display screen of claim 15, wherein the first and second emitters output luminance values corresponding to the left eye frame and the third and fourth emitters output luminance values corresponding to the right eye frame, wherein the first, second, third, and fourth emitters output the luminance values for the left and right eye frames simultaneously.

17. The display screen of claim 11, wherein the first emitter generates visible light of a first color and the second emitter generates visible light of a second color,
wherein, during a first time period, the first emitter is configured to generate a first shade of the first color and the second emitter is configured to generate a first shade of the second color, wherein the first shades comprise wavelengths that are within the first set of wavelengths associated with the left eye frame, and
wherein, during a second time period, the first emitter generates a second shade of the first color and the second emitter is configured to generate a second shade of the second color, wherein the second shades comprise wavelengths that are within the second set of wavelengths associated with the right eye frame.

18. The display screen of claim 11, further comprising:
a tunable optical filter overlaying the plurality of pixels,
wherein, during a first time period, a state of the tunable optical filter is set to filter visible light generated by the first and second emitters such that the filtered light comprises wavelengths that are within the first set of wavelengths associated with the left eye frame, and
wherein, during a second time period, the state of the tunable optical filter is changed to filter the visible light generated by the first and second emitters such that the filtered light comprises wavelengths that are within the second set of wavelengths associated with the right eye frame.

19. The display screen of claim 18, further comprising:
a protective cover, wherein the tunable optical filter is disposed between the protective cover and the plurality of pixels.

20. A computer-readable storage medium including instructions that, when executed by a processor, cause the processor to perform an operation, the operation comprising:
driving a plurality of pixels to output a left eye frame, wherein the left eye frame is associated with a first set of wavelengths, and wherein each of the pixels comprises at least a first discrete emitter and a second discrete emitter, wherein the first and second emitters are configured to generate visible light with different wavelengths; and
driving the pixels to output a right eye frame, wherein the right eye frame is associated with a second set of wavelengths different from the first set of wavelengths, and wherein the left eye frame and the right eye frame generate 3D effects when viewed by a user.
